(19) United States
(12) Patent Application Publication
(10) Pub. No.: US 2014/0340899 A1
(43) Pub. Date: Nov. 20, 2014

(54) Integrated Solid-State Lamp

(71) Applicants: Edward E. Bailey, Westampton, NJ (US); Andrew H. Beregszaszi, Philadelphia, PA (US)

(72) Inventors: Edward E. Bailey, Westampton, NJ (US); Andrew H. Beregszaszi, Philadelphia, PA (US)

(21) Appl. No.: 14/280,642

(22) Filed: May 18, 2014

Related U.S. Application Data
(60) Provisional application No. 61/824,990, filed on May 18, 2013.

(51) Int. Cl. F21V 13/04

(52) U.S. Cl. CPC F21V 13/04
USPC 362/245; 362/249.02

(57) ABSTRACT

An integrated solid-state lamp comprised of thermally conducting materials such as alumina ceramic or graphite filled polymers may simultaneously perform optical operations on the light emerging from solid-state emitters to enable the creation of a lamp which produces light in both direct and indirect light zones with a near-field uniformity more comparable to that produced by a vertical filament incandescent lamp. The light chamber structures may incorporate optical light path modifiers which push light into additional lighting zones for proximately omnidirectional light. Diffuser structures may incorporate hole patterns to improve thermal flow and light recycling efficiency. The distribution produced fully encompasses 0-180 deg. Light produced by the lamp chambers or atrium serve in like manner to the atrial chambers of the heart to produce light uniformly in all directions for general illumination at high efficiency.

### CROSS REFERENCE TO RELATED APPLICATIONS

This application claims priority from U.S. Provisional Patent Application Ser. No. 61/824,990, entitled “Integrated Solid-State Lamp”, filed on 18 May 2013. The benefit under 35 USC §119e of the United States provisional application is hereby claimed, and the aforementioned application is hereby incorporated herein by reference.

### TECHNICAL FIELD OF THE INVENTION

The present invention relates generally to Integrated Solid-State Lamps. More specifically, the present invention relates to an integrated solid-state lamp comprised of combination thermally dissipating optically reflecting chambers producing substantially omnidirectional light.

### BACKGROUND OF THE INVENTION

Many lighting spaces utilize lighting in which the light is produced through the process of incandescence and UV mercury vapor fluorescence. Although incandescence produces high color rendering it suffers from poor luminous efficacy as the majority of the light produced is in the thermal infrared. Fluorescent light sources produce light at much higher efficiency than incandescent heater filaments but it does not produce such light without toxic mercury. First generation solid-state lamps were dominated by the heat sinks required to dissipate the heat from the light emitting diodes, which occluded the light paths required for uniform near-field light distribution.

### SUMMARY OF THE INVENTION

An integrated solid-state lamp comprised of thermally conducting materials such as alumina ceramic or graphite filled polymers may simultaneously perform optical operations on the light emerging from solid-state emitters to enable the creation of a lamp which produces light in both direct and indirect light zones with a near-field uniformity more comparable to that produced by a vertical filament incandescent lamp. By producing a lamp which allows for light emerging from the heat sink chambers themselves, a more pleasing, uniform area light effect is produced whereas in the past such heat sink surfaces were dark. In addition the heat sink/optical structures and chambers allow for direct printing of electrical circuits for delivering power and control to individual solid-state emitters.

The light chamber structures may incorporate optical light path modifiers which push light into additional lighting zones for proximately omnidirectional light. Diffuser structures may incorporate hole patterns to improve thermal flow and light recycling efficiency. The distribution produced fully encompasses 0-180 deg with 0 degree representing a polar vector pointing directly upward from the lamp and 180 deg directly downward in the direction of the electrical contact or base. Light produced by the lamp chambers or atrium serve in like manner to the atrial chambers of the heart to produce light uniformly in all directions for general illumination at high efficiency.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an incandescent vertical filament A19;

FIG. 2 illustrates a CFL lamp;

FIG. 3 illustrates a LED lamp with large heat sink;

FIG. 4 illustrates a direct/indirect chamber lamp;

FIG. 5 illustrates a tip view of a direct/indirect lamp assembly;

FIG. 6 illustrates a perspective view of a direct/indirect direct attach light source assembly;

FIG. 7 illustrates a direct/indirect lamp interleave interconnect system;

FIG. 8 illustrates an exploded view of a direct/indirect lamp assembly;

FIG. 9 illustrates a direct/indirect lamp heat sink, electrical circuit;

FIG. 10 illustrates a direct/indirect lamp thermal CFD flow path;

FIG. 11 illustrates a direct/indirect lamp thermal CFD flow path diffuser holes;

FIG. 12 illustrates a direct/indirect lamp optical control panels and electrical driver;

FIG. 13 illustrates a direct/indirect diffuser holes light path;

FIG. 14 illustrates a lamp intensity distribution;

FIG. 15 illustrates a flow trajectory map through optical light chambers;

FIG. 16 illustrates a flow trajectory through thermal dissipation structures;

FIG. 17 illustrates a symmetric optical light cavity comprised of thermal dissipation structure;

FIG. 18 illustrates a half primitive optical light cavity and thermal structure;

FIG. 19 illustrates a polar array optical light/thermal structure cavity octo.

### DETAILED DESCRIPTION OF THE INVENTION

In the following detailed description of the invention of exemplary embodiments of the invention, reference is made to the accompanying drawings where like numbers represent like elements, which form a part hereof, and in which is shown by way of illustration specific exemplary embodiments disclosing how the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the Figures, it is possible to see the various major elements constituting the apparatus of the present invention. The enclosed Figure drawings are intended to illustrate the Integrated Solid-State Lamp.

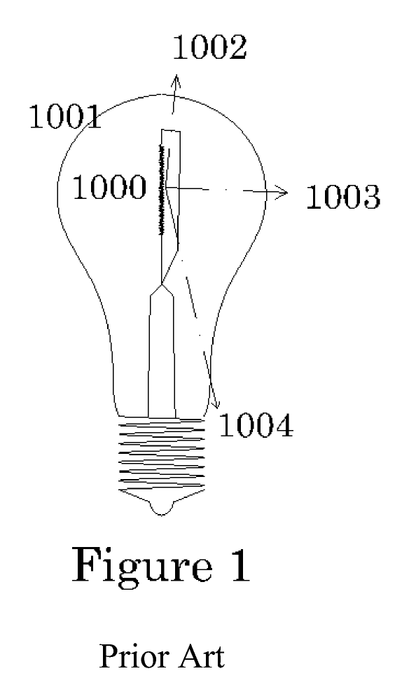

FIG. 1 demonstrates prior art pertaining to a vertical filament incandescent lamp which produces light at high color rendering, but at the expense of luminous efficacy. The light produced is omnidirectional, exhibiting high color fidelity, and high near-field illumination uniformity. The incandescent lamp illuminates in all directions sourced through item 1000, the CC or coiled-coil vertical tungsten filament. The incandescent bulb is protected by a thin soda-lime glass shell 1001 which is substantially spherical in shape to transfer light from the filament 1000 to air. As light emanates from the filament 1000 it produces light in a directional zone above the light 1002, as well as laterally 1003 and in the indirect zone 1004. The primary advantage of the omnidirectional distribution of the light 1004 is that it emanates all the way down near the screw base. When utilized with a frosted glass shade proximally near the incandescent lamp the glass decorative shade illuminates uniformly from the base attachment to the top. The light distribution in the near-field of the lamp between zones 1003 and 1004 is critical to uniform illumination.

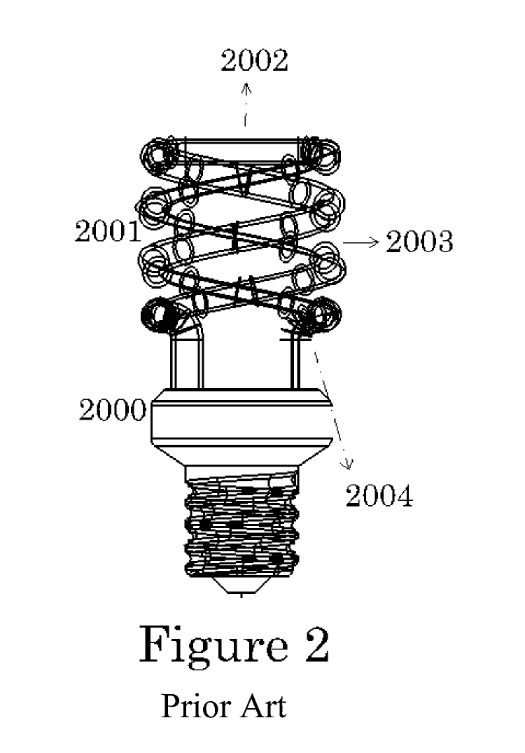

FIG. 2 depicts a prior CFL or compact fluorescent lamp comprises of an electronic ballast or base 2000, and a coil of phosphor coated glass 2001 which is pumped by means of a mercury filled UV gas. As can be seen the CFL lamp produces light primarily in the upper half of the lamp envelope. Although light is produced in the three critical zones direct 2002, lateral 2003 as well as indirect 2004, a substantial portion of the indirect light 2004 is blocked by the ballast casing. No light is emerging from the lamp below the fluorescent coil or from the ballast casing which results in a dark area on the bottom half of a proximal frosted or clear glass shade.

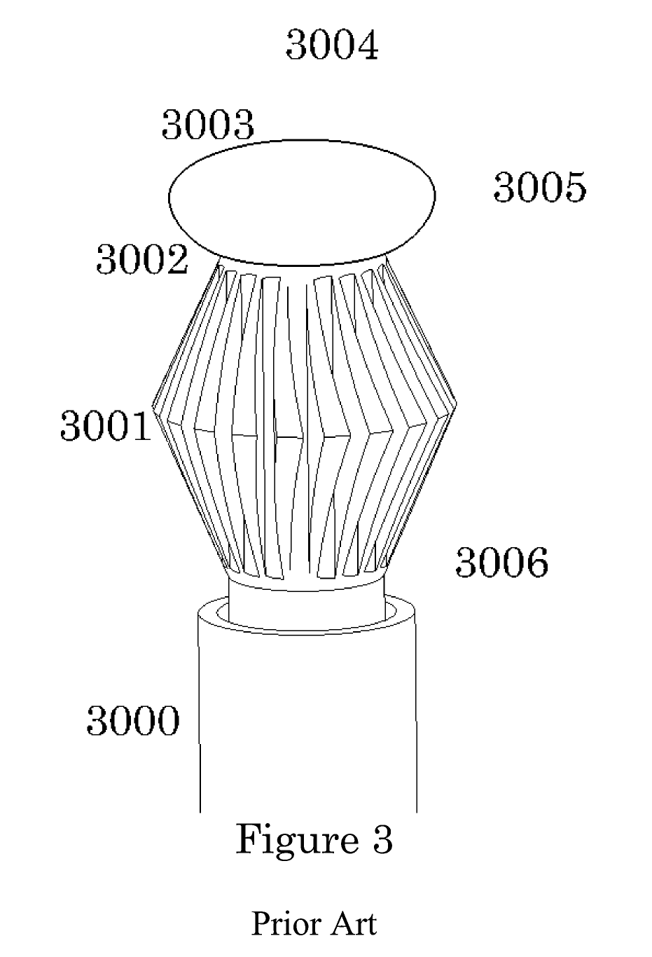

FIG. 3 depicts a prior LED or light emitting diode lamp comprised of an electrical contact base 3000, a large finned heat sink 3001, an LED light source 3002 within a diffuser shell of an ellipsoidal shape 3003 to produce light in the three zones, direct 3004, lateral 3005, and indirect 3006. A retrofit lamp has a contact screw or bi-pin to transfer electrical power from mains to the driver or current regulator contained in the LED lamp housing. The bored out heat sink 3001 contributes to the thermal dissipation of the heat but to do so it obstructs or occludes the light emanating from the ellipsoidal diffuser 3003. Although the light emanating from the lamp is omnidirectional in nature it requires sufficient distance from the source to uniformly illuminate. Frosted glass shades close to the lamp will appear dark in the bottom half of the lamp because the light path must travel from the top part of the lamp to the bottom, rather than direct from the bottom half of the lamp. The heat sink materials are usually a dark grey in color due to the alloy elements such as silicon comprised within the die-case aluminum. The net result is a high efficiency lamp with a poor illumination appearance. Although the lamp has excellent thermal dissipation properties it does not look like a light source.

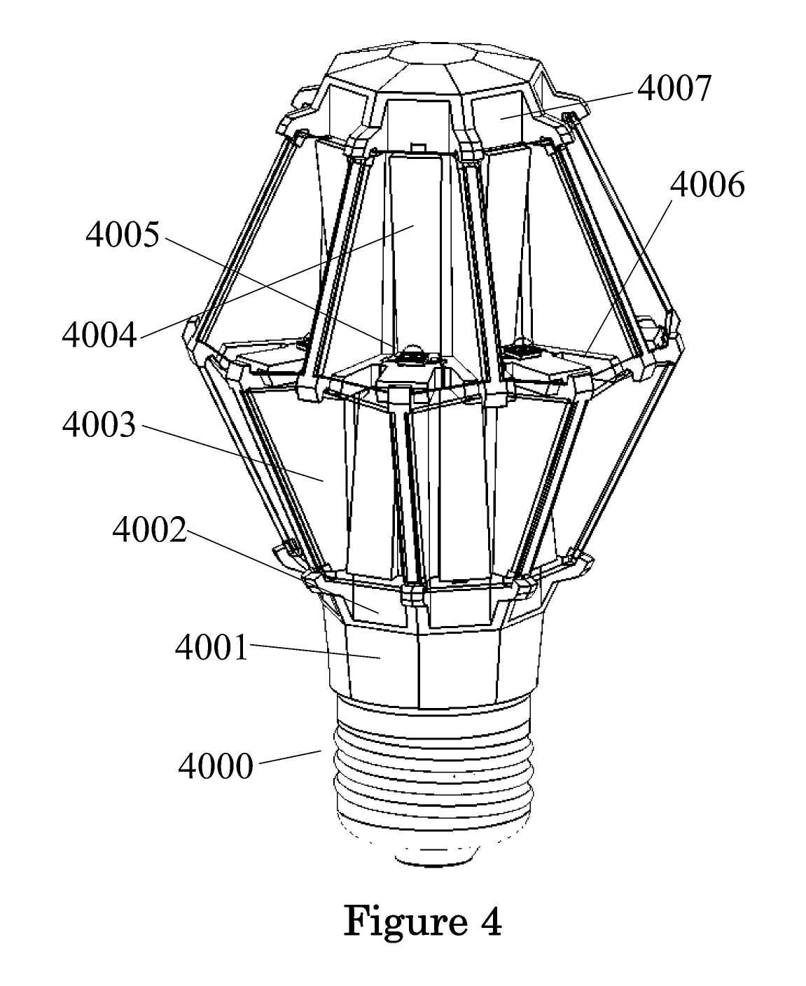

FIG. 4 represents a novel solution to the short-comings of incandescent lamps, CFL, and first generation LED lamps with large obstructing heat sinks The solid-state lamp comprises light emission chambers 4003 angled both upward and downward. The solid state light emitting elements 4005 are positioned to produce light in direct, lateral, and indirect zones without any heat sink obstruction. Whereas most LED lamps emit light only from the top half of the bulb, the multi-chamber light disclosed emits light from over 75% of the surfaces. Item 4000 represents a screw base contact, although a GU24 or bayonet base may also be used. 4001 represents an isolation base comprised of a white ceramic or thermally conducting polymer.

The isolation base serves to both isolate electrically as well as scatter light optically emerging from the downward facing LED array. The cooling vent 4002 allows the lamp to breathe air from the bottom through and around the LED's to the top escape 4007. Side wall panels 4003 become light emission surfaces when illuminated by the LED light sources 4005. Light emerging from the light array devices 4005 also can be kicked down or upward by means of the light direction surfaces 4004. Both light and air may also pass from the top half of the lamp to the bottom or vice versa by means of the flow slots 4006.

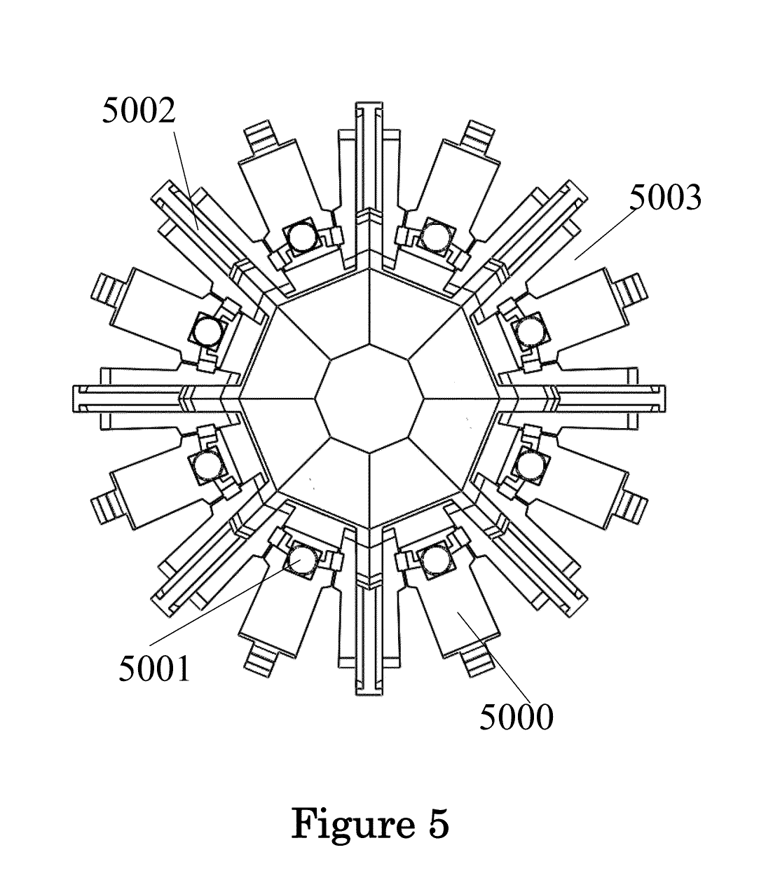

FIG. 5 depicts a top view of the enclosed invention including the light array panel 5000 upon which the LED's are directly attached 5001, as well as the heat sink spars 5002 which provide structure to the lamp as well as dissipate heat. Slots 5003 around the lamp allow for bi-directional traversal of both light and air throughout the lamp. As seen from the top view 8 chambers are used, but this is not a limitation. 2 chambers, 3, 4, or up to 50 chambers or subdivisions may also be used to produce the light. Also of note is that the light emanating from the LED's 5001 shown are not in direct view to the observer when looking from the top as diffusion panels may be used to soften the light appearance.

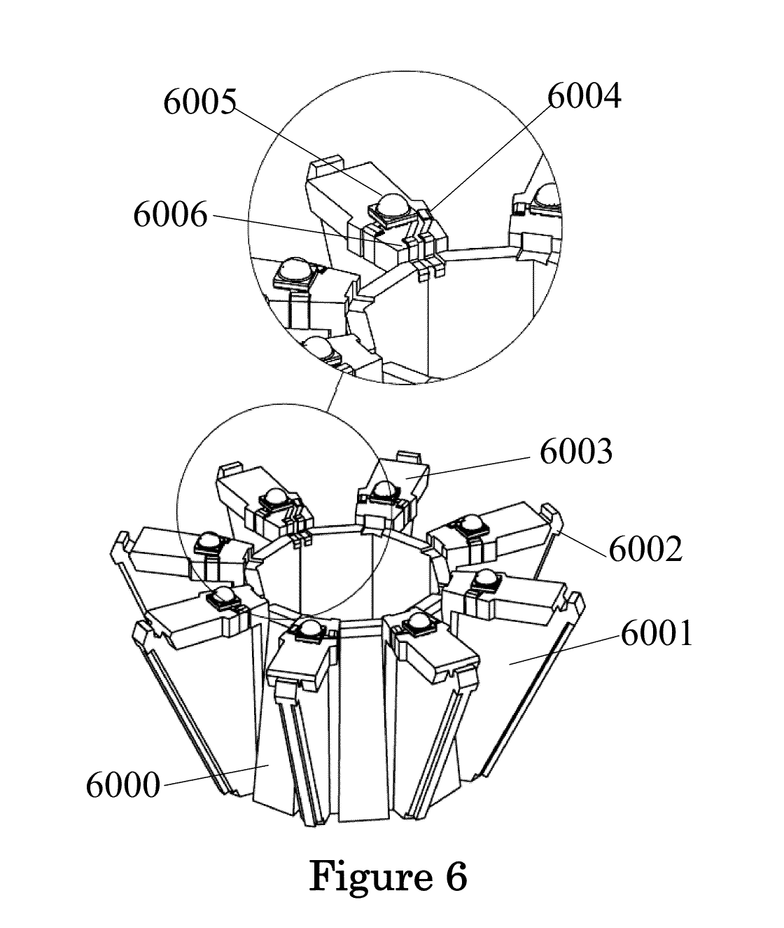

In another embodiment shown in FIG. 6, a heat sink part comprising multiple light chambers, LED's, and electrical circuits. The electrical circuits 6006 may be printed directly on the thermally conducting, optically active surfaces removing the need for a separate PWB or printed wiring board (PWB). The printed wiring board produces more thermal resistance and thickness to the lamp which is not needed. The use of a PWB increases the temperature of the solid-state emitters or die due to the thermal resistance interface between the PWB and the heat sink and added thermal resistance of the solder mask layer. By utilizing a heat sink with integrated light chambers as shown the top channel and bottom channels of light may be interleaved for production of the omnidirectional light.

Chamber surfaces of importance include the side panels 6001, the kicker optical surface 6000, the diffuser hangers 6002, and the bottom panel surface 6003. Also the LED's 6005, are interconnected to each other by means of a conductive part 6004 and each string of LED's on the panel is connected to the core by means of internal connects 6006. The LED's or solid-state emitters are placed towards the center of the lamp approximately 20 mm from a virtual center-line passing through the lamp. The primary thermal dissipation primitive fin serves the dual purpose of thermal conduction and light reflection. The bottom thermal structure fins and optical light chambers have an array of LED's attached to the flat plane to source the top optical light chambers.

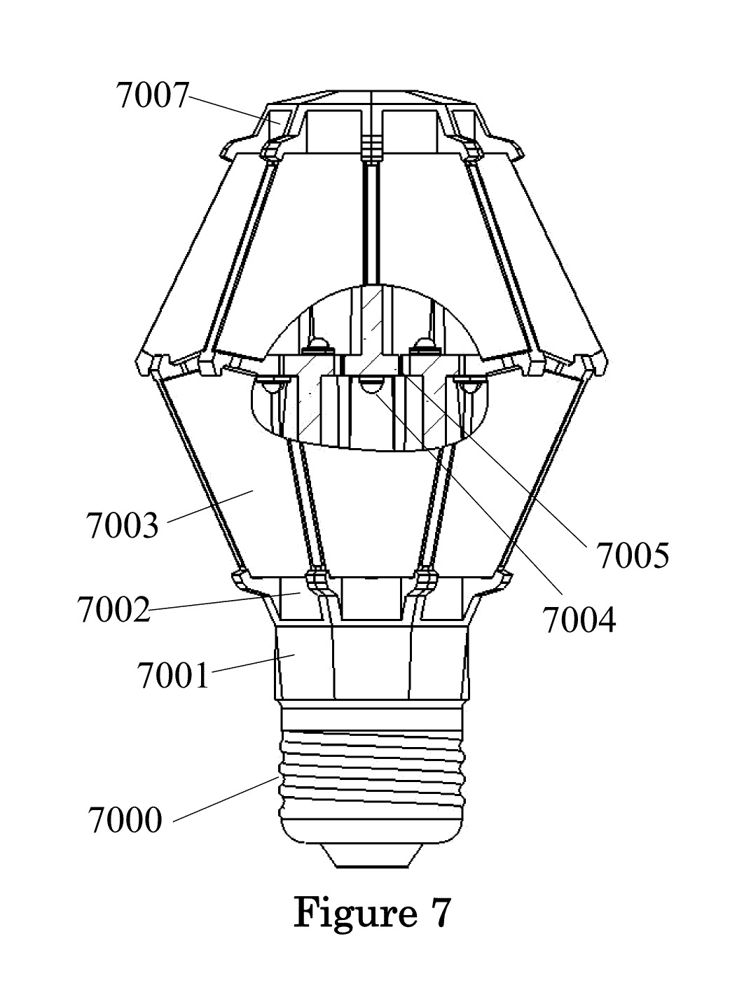

FIG. 7 embodies a complete lamp assembly including the screw base electrical contact 7000, the ceramic electrical isolator 7001, and the diffuser holder part 7002, which holds the optical diffusers 7003 covering the optical cavities. The light source arrays 7004 interconnected to each other by means of a serpentine electrical pathway 7005 illuminate the optical cavities which shape and direct the light to the outside air. Cooling air flow enters through port 7002, then flows around the light sources. Air traverses vertically through the lamp, exiting at distributed exhaust ports 7007. The net effect of the panel array source is to produce a lantern appearance which distributes light evenly in all directions.

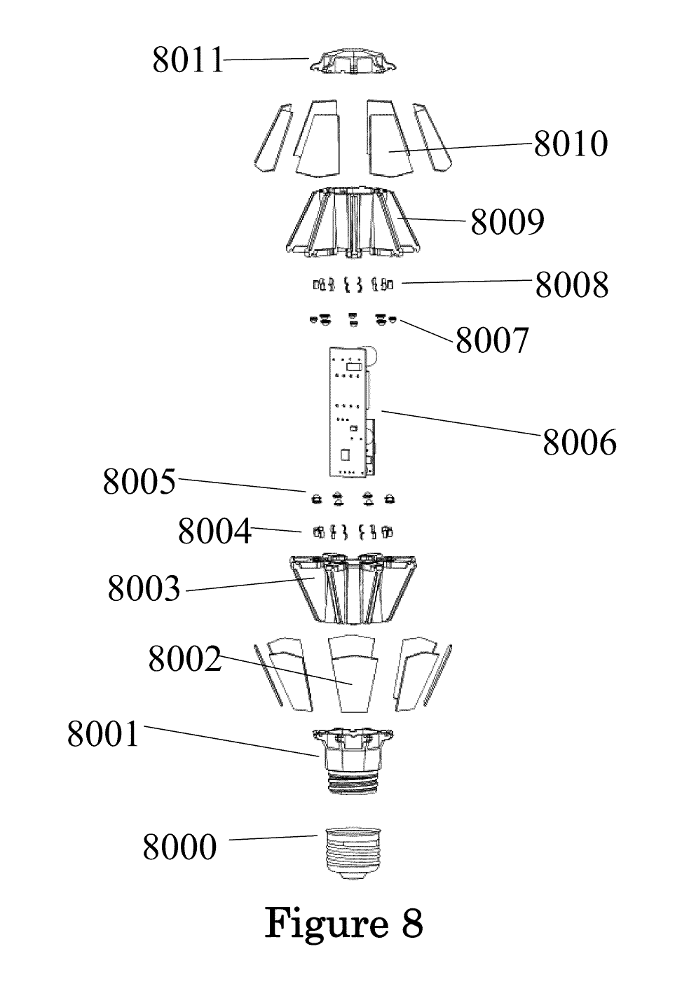

FIG. 8 embodies an exploded view of the integrated solid state lamp comprised of a critical assembly of components. The electrical base 8000 is an Edison E26 screw, although GU24, bayonet, or other electrical contact structures are allowed. The isolator part 8001 is comprised of a ceramic, although other electrically isolating materials may be used. The isolator serves the dual purpose of providing a lamp base holder as well as holding the diffusers 8002 in place. The array of diffusers homogenizes light emerging from the light cavities 8003, which also provide thermal dissipation. The internal walls of the chambers reflect light within many times to produce a pentagonal light chamber. LED or other solid-state light sources 8005 and 8007 receive power through an interconnected network 8004, 8008.

The constant current power supply or driver 8006 converts AC to DC power is housed within the central core of the lamp. The upper light chamber/heat sink 8009 has LED's on the bottom face or flat surface to source the light cavities 8003 and vice versa. The LED's placed on the top surface of heat sink/light chamber array 8003 source the light cavities comprised within the symmetric and rotated 8009 light chamber/heat sink array.

The diffuser array 8010 is comprised of glass or polymer structures which may include micro-structure, textures, holes, or impregnated dissimilar refractive index loading to diffuse the light.

The top part 8011 holds the diffuser array 8010 into place and is intimately connected to the heat sink/light chamber part 8009 to dissipate heat to the air.

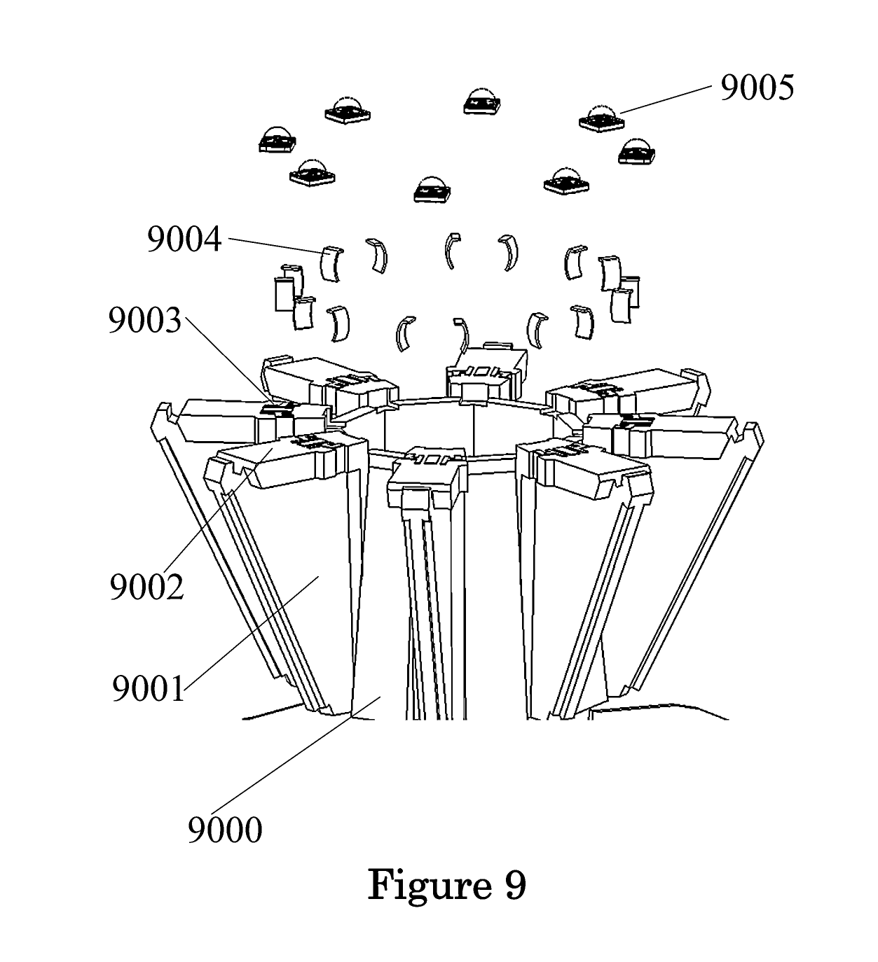

In this embodiment of an 8×2 chamber light the 8 cell chamber is rotated 22.5 degrees to interleave the light cavities thereby removing dark line stripes in near-field illumination. The direct attachment of the LED's 8005, 8007 to the ceramic heat sinks reduces thermal resistance, lowers die/phosphor temperatures, and improves light output, efficiency, and life of the lamp. No PWB or printed wiring board is used, as the circuits are directly printed onto the ceramic using a conductive material such as Ag, or Al. FIG. 9 embodies an assembly of components which comprise one half of the integrated chamber light. Part 9000 is a kicker optical surface, or light field correction element which can spread light, push light up towards the center and outside of the lamp or spread the light laterally if a concave curve were applied to the surface. The lateral surfaces of the light chamber 9001 direct light laterally to uniformly illuminate the chamber. The chambers have high reflectance, 97% or higher to recycle the light emerging from the matching upper half light chamber. The

LED array 9005 sources the upper optical light chamber. The heat transferring through the heat sink 9001 is distributed evenly through the light chamber structures. Light surface 9002 reflects light with a Lambertian scatter distribution into the upper light chamber. The LED's or solid-state emitters are attached directly to an electrical circuit 9003 on the flat surface of the heat sink part 9001. Interconnects 9004 distribute electrical power through the lamp. The direct attachment of the LED's to the heat sink/light chambers reduces complexity, improves performance of the lamp, reduces the junction temperature of the LED chips, and boosts efficacy. The light chambers themselves may be comprises of a highly reflective ceramic material which is thermally conductive >25W/m*K and easy to print circuits upon.

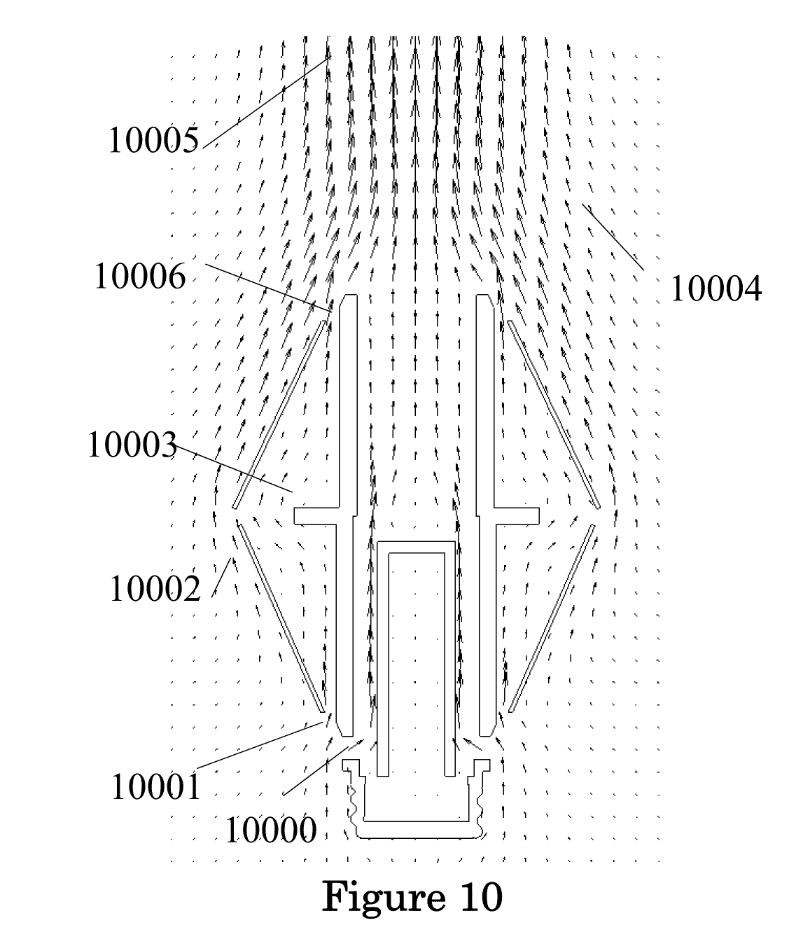

FIG. 10 depicts an alternate light chamber design in which the heat flows through 3 primary paths. Cool air may flow internally entering at entrance port 10000 and flow through the center of the lamp as shown by the heat flow trajectory map. Cool air may also enter at port 10001 between the diffuser and the optical element of the light chambers and thereby flow around the LED light sources internal to the lamp. Additional air flows around the lamp 10002 providing cooling to the exposed heat sink fins on both sides of the light chambers between the diffuser panels. Air which flows close to the LED 10003 may recirculate through the lamp. Outflow 10006 is higher in temperature which then flows into plume 10005 at higher velocity towards the center of the lamp as compared to the outside 10004.

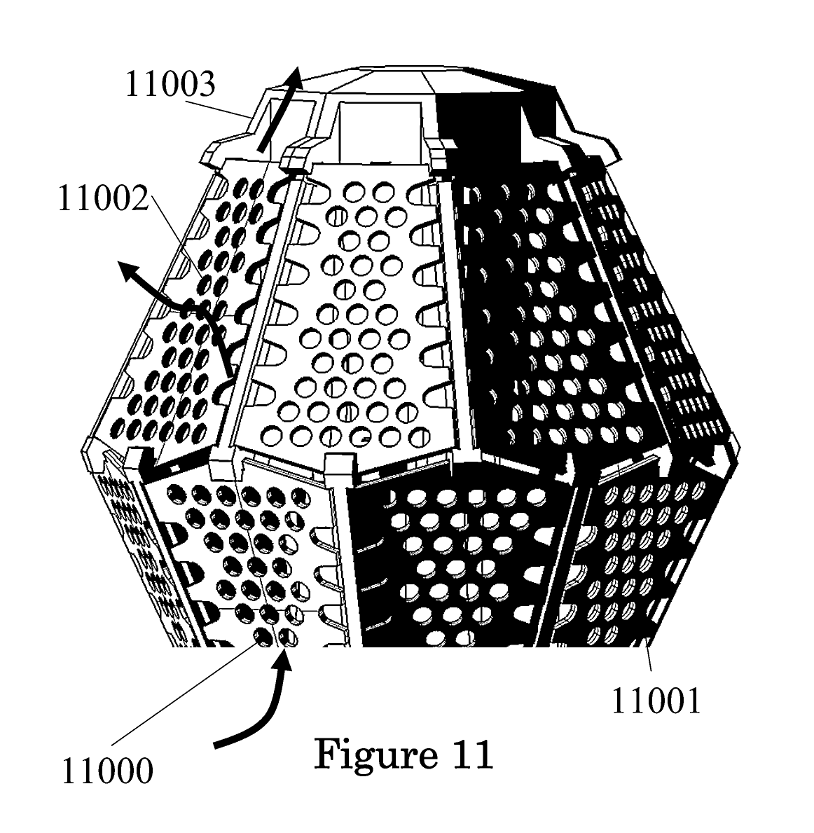

FIG. 11 embodies an alternative diffuser configuration 11000 in which the diffusers are comprised of holes, slots, or other patterns to allow air flow throughout the lamp as well as diffusion of the light. Fresnel losses are reduced proportional to the air hole area. As shown cool air may inflow at 11000 or through 11001 and then exit laterally through the array of holes 11002 and through the exhaust port 11003 of the light chamber. The net effect of the distributed holes on the diffusers is to reduce the temperature of the lamp.

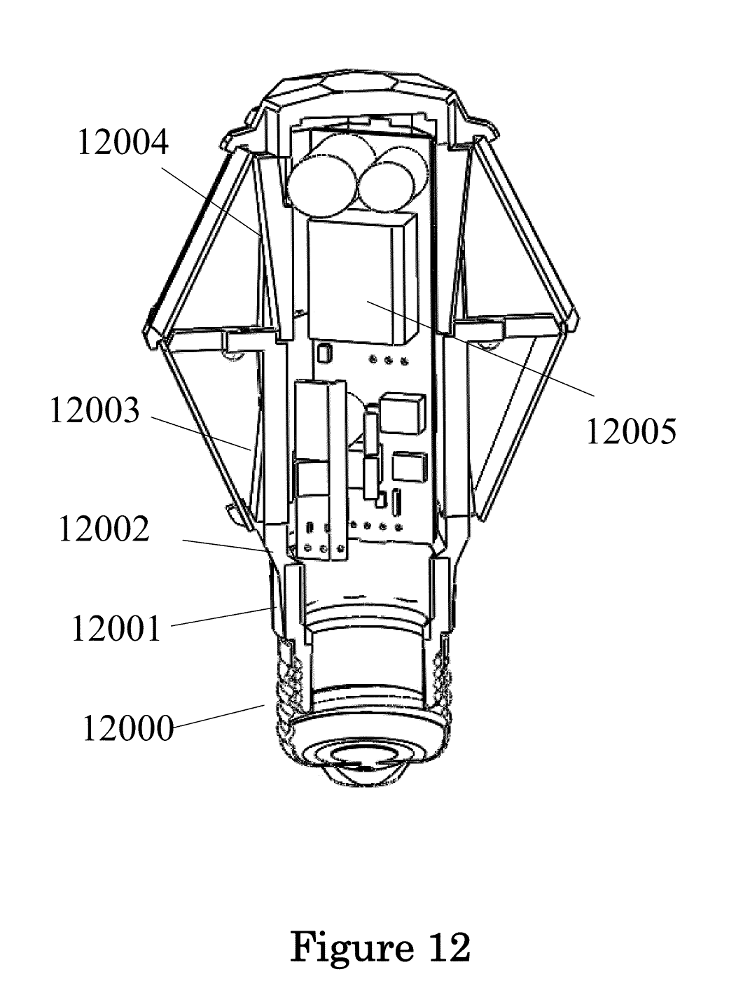

FIG. 12 shows the screw contact base 12000, the isolator part 12001, which is intimately attached to the heat sinks/light chambers 12003. Also shown is the light director surface 12004 which pushes light down ward from the top of the light cavity towards the center of the lamp. As the LED's are producing light substantially upward or directly downward the light control surfaces 12004 serve to further direct light where needed filling out intensity zones uniformly. The LED driver 12005 is housed within the central core of the lamp allowing sufficient volume for dimming, isolation, and other power signal control.

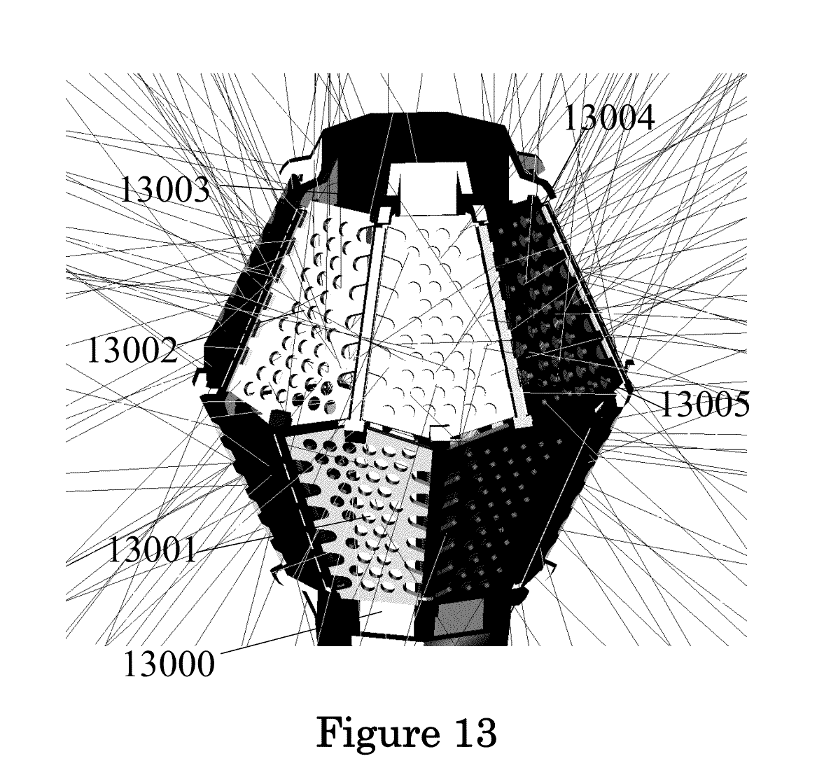

FIG. 13 shows the light ray paths 13002, 13004, 13005 throughout the lamp. Surface 13000 is the light control surface within the light chamber which illuminates from light directed from the internal LED source array. The light passes to the air more efficiently due to the small holes 13001, 13002 or slots 13005 of the diffuser array panels.

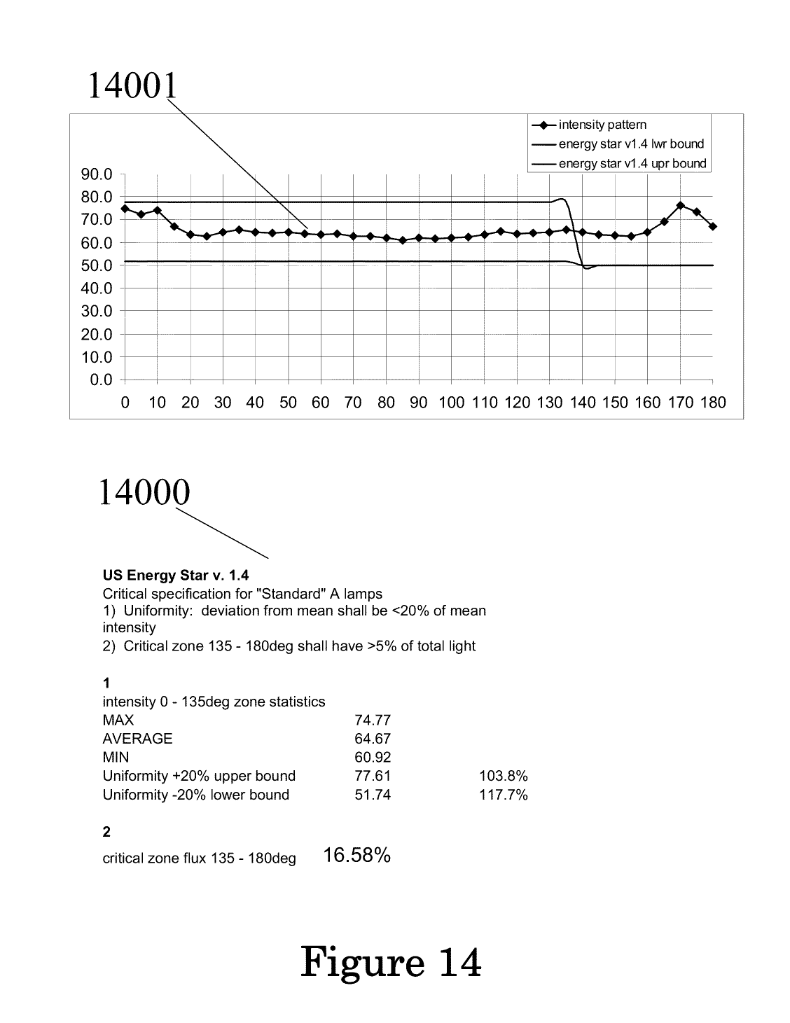

FIG. 14 depicts the light intensity pattern 14001 of the lamp when the top and bottom

LED arrays produce equal light. As seen the light produced is highly omnidirectional producing light from 0 to 180 deg. Other lights cannot produce light down to 180 deg due to heat sink occlusion. The novel lamp disclosed produces up to 16.6% of the light within the 135-180 degree indirect zone. Also the uniformity of the light is high to enable compliance with the department of energy specifications for standard A lamps 14000 which requires <20% mean intensity variation.

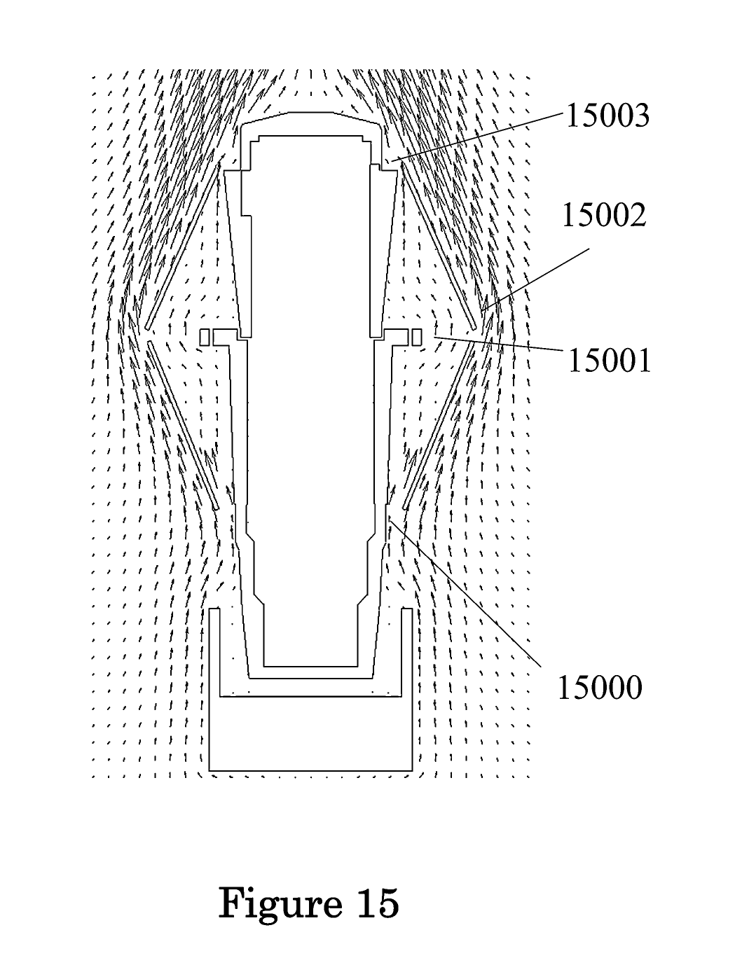

FIG. 15 embodies a diagram of the air flow paths around and through the lamp including an inflow port 15000, flow around the LED's 15001, flow around the outside of the lamp 15002, and exhaust flow through the top of the light chamber 15003 to the surrounding environment. Air flow around and through the lamp reduces the operating temperature of the lamp and ensures long life of the light emission elements.

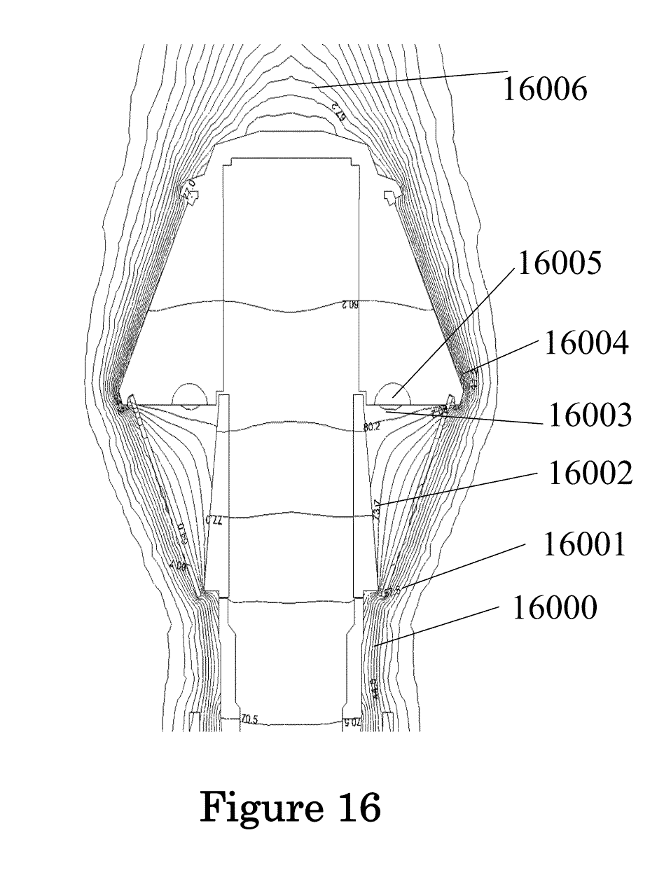

FIG. 16 shows a second slice through the heat sink/light chamber assembly in which the cut view shows the isolines of heat flow gradients. Air enters the light near 16000 at approximately 45 degrees, then begins to heat up 16001 to 57 deg. Temperatures in the chamber 16002 at 73 and closest to the LED emitter 16003 are approximately 80 deg with a 12 watt heat load produced by the LED arrays. The isolines through the solid material of the heat sink are representative of a ceramic material, and light source distribution arrayed in a ring 20 mm from the centerline of the lamp. Strong heat gradients near 16004 show the champion heat dissipation surfaces, or surfaces of importance for dissipation to air of the heat emerging from 16003 directly underneath the LED. The air plume 16006 is approximately 67 degree in this embodiment which shows that the lamp has successfully pulled air in from the bottom 16000 and transferred heat to the air to be carried away.

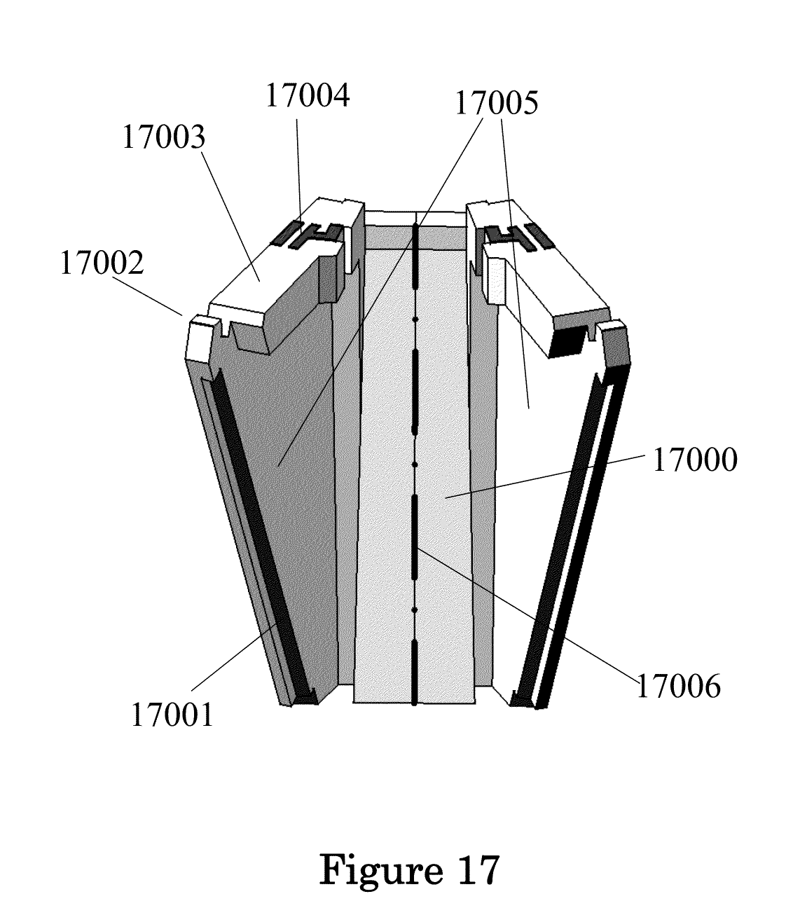

FIG. 17 embodies the primary light chamber/heat sink element of the lamp and is the most fundamental part of the lamp invention. The light cavity comprises several important features including a light control device 17000, a diffuser shelf 17001, lateral light homogenization and heat dissipation fins 17005, a hangar or diffuser holder element 17002 a flat light direction surface 17003 upon which an electrical circuit 17004 sources power to the LED's. The centerline shown 17006 represents the symmetry fold of the light chamber/heat sink element. The angle, rake, surface texture of the light chamber may be modified to produce light homogenization to illuminate the diffuser element panels comprised of pentagon, hexagonal, or other shapes. The dual role of the heat sink fins 17001, lateral walls 17005, and flat optical surface 17003 demonstrate an integrated approach to solid-state light production. Integration refers to the unification of optical, illumination, and thermal purposes into one element for the purpose of providing the net advantage of uniform illumination.

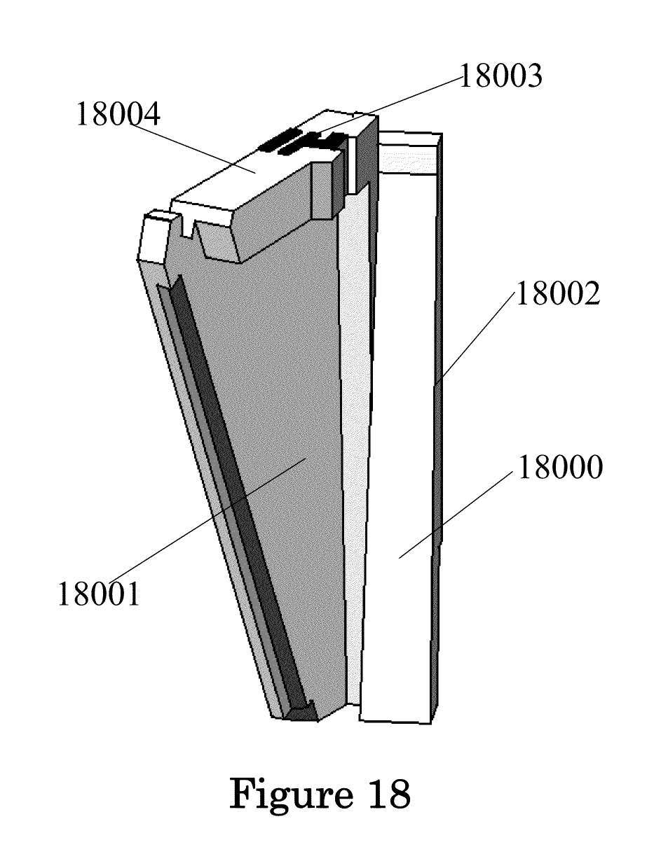

The FIG. 18 embodiment shows the most fundamental primitive of the entire lamp assembly. Comprised of primary light control surface 18000 which may be flat, concave, convex, or free-form, a lateral chamber surface 18001 which homogenizes light emerging from an interleaved LED attached to the top chamber/heat sink array, a flat light control surface 18004 nearest to the directly printed electrical circuit 18003. The symmetry fold at 18002 represents one half of one chamber element. When folded to form a singular cavity, and then polar arrayed into 3, 4, 6, 8, 12 chambers, etc the net effect is a pleasing illumination source in which light emerges from the entire lamp rather than smaller elements at the top of the lamp distinctly separate from the occluding heat sink of the solid-state lamp.

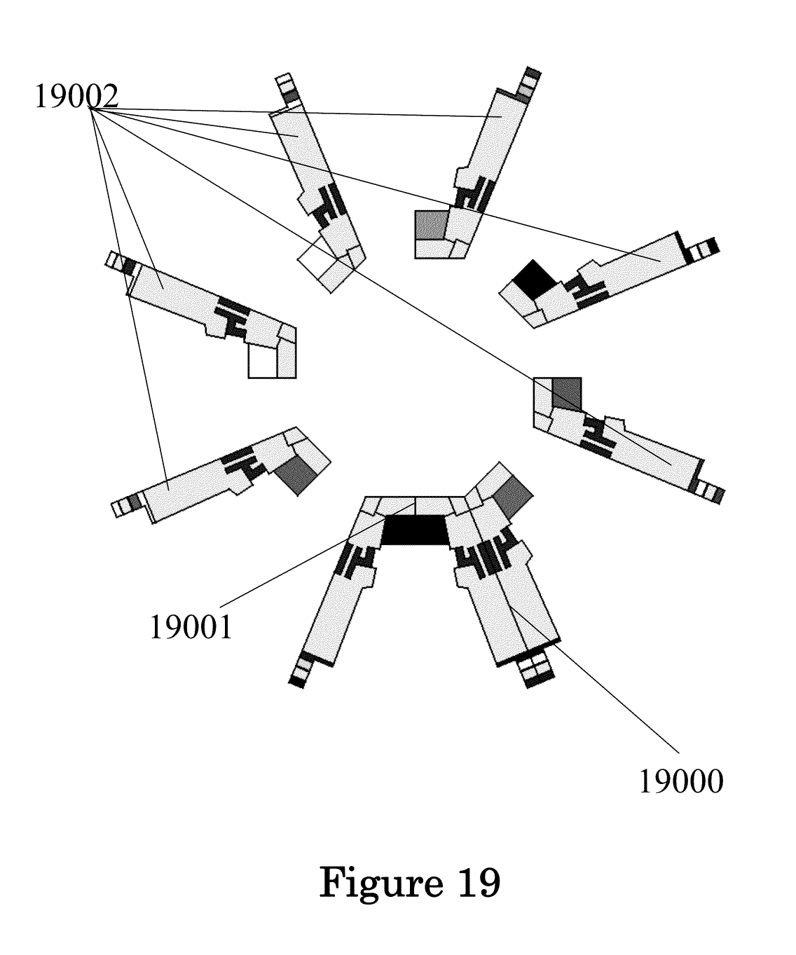

The FIG. 19 embodiment depicts the bottom half of a novel 8-chamber lamp design. The symmetry line 19000 of the primitive light chamber element of FIG. 18 is clearly shown, including the symmetric fold at 19001 to form one homogenous light chamber and heat sink dissipation element. The primary light chamber is then arrayed in a polar pattern around the centroid. Each angular subset of the primitive chamber element of FIG. 17, 19002 produces light to fill 360 as seen from the top of the lamp. Although shown in a circular array, the light chambers may array along an arbitrary free-form curve to produce other light source panels which do not conform to an ambient light source shape.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An Integrated Solid-State Lamp comprising:
one or more light emission chambers angled both upward and downward;
one or more solid state light emitting elements positioned to produce light in direct, lateral, and indirect zones without any heat sink obstruction;
a base contact representing an isolation base comprised of a white ceramic, or thermally conducting polymer;
the isolation base serves to both isolate electrically as well as scatter light optically emerging from the downward facing LED array;
a cooling vent allowing the lamp to breathe air from the bottom through and around the LED's to a top escape;
side wall panels becoming light emission surfaces when illuminated by the LED light sources; and
one or more flow slots allowing both light and air may also pass from the top half of the lamp to the bottom half of the lamp or vice versa.

2. The Integrated Solid-State Lamp of claim 1, wherein the base contact is either a screw, GU24, or bayonet base contact.

3. The Integrated Solid-State Lamp of claim 1, further comprising light direction surfaces directing light emerging from the light sources down or upward.

4. The Integrated Solid-State Lamp of claim 1, further comprising
one or more chambers or subdivisions;
a light array panel upon which the LED's are directly attached.
one or more heat sinks which provide structure to the lamp as well as dissipate heat;

5. The Integrated Solid-State Lamp of claim 4, wherein the heat sinks are further comprised of multiple light chambers, LED's, and electrical circuits.

6. The Integrated Solid-State Lamp of claim 5, wherein the electrical circuits are printed directly on the thermally conducting, optically active surfaces.

7. The Integrated Solid-State Lamp of claim 4, wherein the heat sink is integrated with the light chambers whereby the top channel and bottom channels of light may be interleaved for production of the omnidirectional light.

8. The Integrated Solid-State Lamp of claim 7, wherein chamber surfaces are further comprised of
a plurality of side panels;
a kicker optical surface;
diffuser hangers; and
a bottom panel surface.

9. The Integrated Solid-State Lamp of claim 1, wherein
the LED's or solid-state emitters are interconnected to each other by a conductive part and each string of LED's on the panel is connected to the core by internal connects;
the LED's or solid-state emitters are placed towards the center of the lamp approximately 20 mm from a virtual center-line passing through the lamp;
a primary thermal dissipation primitive fin serves the dual purpose of thermal conduction and light reflection; and
one or more bottom thermal structure fins and optical light chambers have an array of LED's attached to the flat plane to source the top optical light chambers.

10. The Integrated Solid-State Lamp of claim 1, wherein a complete lamp assembly includes
the screw base electrical contact;
the ceramic electrical isolator;
the diffuser holder which holds the optical diffusers covering the optical cavities;
the light source arrays interconnected to each other by means of a serpentine electrical pathway illuminate the optical cavities which shape and direct the light to the outside air;
one or more intake ports enabling cool air flow to enter and then flow around the light sources; and
one or more exhaust ports allowing the air entering from the intake ports to traverse vertically through the lamp, exiting at the distributed exhaust ports.

11. The Integrated Solid-State Lamp of claim 1, wherein an assembly of components which comprise one half of an integrated chamber light comprises:
a kicker optical surface, or light field correction element which can spread light, push light up towards the center and outside of the lamp or spread the light laterally if a concave curve were applied to the surface;
one or more lateral surfaces of the light chamber direct light laterally to uniformly illuminate the chamber;
the chambers have high reflectance, 97% or higher to recycle the light emerging from the matching upper half light chamber
the LED array sources the upper optical light chamber;
the heat transferring through the heat sink is distributed evenly through the light chamber structures;
the light surface reflects light with a Lambertian scatter distribution into the upper light chamber;
the LED's or solid-state emitters are attached directly to an electrical circuit on the flat surface of the heat sink part; and
interconnects distribute electrical power through the lamp.

12. The Integrated Solid-State Lamp of claim 1, wherein
cool air may flow internally entering at one more entrance ports and flow through the center of the lamp;
cool air may also enter at a port between the diffuser and the optical element of the light chambers and thereby flow around the LED light sources internal to the lamp;
additional air flows around the lamp providing cooling to the exposed heat sink fins on both sides of the light chambers between the diffuser panels;
air which flows close to the LED recirculates through the lamp.

13. The Integrated Solid-State Lamp of claim 1, wherein
diffusers are comprised of holes, slots, or other patterns to allow air flow throughout the lamp as well as diffusion of the light; and
Fresnel losses are reduced proportional to the air hole area

14. The Integrated Solid-State Lamp of claim 1, wherein
the screw contact base and the isolator part are intimately attached to the heat sinks/light chambers;
the light director surface pushes light down ward from the top of the light cavity towards the center of the lamp;
the LED's are producing light substantially upward or directly downward the light control surfaces serve to further direct light where needed filling out intensity zones uniformly; and
the LED driver is housed within the central core of the lamp allowing sufficient volume for dimming, isolation, and other power signal control.

15. The Integrated Solid-State Lamp of claim 1, wherein the light intensity pattern of the lamp when the top and bottom LED arrays produce equal light is highly omnidirectional producing light from 0 to 180 deg. producing up to 16.6% of the light within the 135-180 degree range.

16. The Integrated Solid-State Lamp of claim 1, wherein the light cavity comprises
a light control device;
a diffuser shelf;
one or more lateral light homogenization and heat dissipation fins,
a hangar or diffuser holder element; and
a flat light direction surface upon which an electrical circuit sources power to the LED's.

17. The Integrated Solid-State Lamp of claim 16, wherein the angle, rake, and surface texture of the light chamber may be modified to produce light homogenization to illuminate the diffuser element panels comprised of pentagon, hexagonal, or other shapes.

18. An Integrated Solid-State Lamp assembly comprising:
a primary light control surface which may be flat, concave, convex, or free-form;
a lateral chamber surface which homogenizes light emerging from an interleaved LED attached to a top chamber/heat sink array;
a flat light control surface nearest to a directly printed electrical circuit;
when the assembly is folded symmetrically to form a singular cavity, and then polar arrayed into 3, 4, 6, 8, 12 or more chambers the net effect is an illumination source in which light emerges from the entire lamp rather than smaller elements at the top of the lamp distinctly separate from the occluding heat sink of the solid-state lamp.

19. The Integrated Solid-State Lamp of claim 18, wherein
an 8-chamber lamp design folded from a singular primitive light chamber forms one homogenous light chamber and heat sink dissipation element;
the primary light chamber is arrayed in a polar pattern around the centroid; and
each angular subset of the primitive light chamber element produces light to fill 360 degrees as seen from the top of the lamp.

20. An Integrated Solid-State Lamp comprising:
an electrical base being either an Edison E26 screw, GU24, bayonet, or other electrical contact structure;
and isolator comprised of a ceramic, providing a lamp base holder as well as holding the diffusers;
an array of diffusers homogenizes light emerging from the light cavities, which also provide thermal dissipation;
the internal walls of the chambers reflect light a plurality of times to produce a pentagonal light chamber;
LED or other solid-state light sources receive power through an interconnected network;
A constant current power supply or driver converts AC to DC power is housed within the central core of the lamp;
an upper light chamber/heat sink has LED's on the bottom face or flat surface to source the light cavities and vice versa;
LED's placed on the top surface of heat sink/light chamber array source the light cavities comprised within the symmetric and rotated light chamber/heat sink array;
the diffuser array is comprised of glass or polymer structures which may include micro-structure, textures, holes, or impregnated dissimilar refractive index loading to diffuse the light.;
top part holds the diffuser array into place and is intimately connected to the heat sink/light chamber to dissipate heat to the air;
an 8 cell chamber is rotated 22.5 degrees to interleave the light cavities thereby removing dark line stripes in near-field illumination; and
the direct attachment of the LED's to the ceramic heat sinks reduces thermal resistance, lowers die/phosphor temperatures, and improves light output, efficiency, and life of the lamp.
